(19) United States
(12) Patent Application Publication
(10) Pub. No.: US 2012/0193458 A1
(43) Pub. Date: Aug. 2, 2012

(54) System and Method for Attaching a Mobile Fogger to a Vehicle

(75) Inventors: Jason Wheeler, Panhandle, TX (US); Terry Wheeler, Panhandle, TX (US)

(73) Assignee: Wheeler Forgger, LLC, Amarillo, TX (US)

(21) Appl. No.: 13/017,014

(22) Filed: Jan. 30, 2011

(51) Int. Cl. B05B 3/00

(52) U.S. Cl. 239/722

(57) ABSTRACT

A mobile fogging system and method are disclosed. Specifically, a mobile fogging system comprising a base, a fogging system, and a hitch-receiver. Wherein, said fogging system is capable of spraying a mixture of a chemical and pressurizes air. Said fogging system is attached to said base. Further, said base is attached to a first end of said hitch-receiver, and a second end of said hitch-receiver is attached to a vehicle. Likewise, a mobile fogging method is also disclosed. Said mobile fogging method comprises attaching a fogging system to a base, attaching said base to a hitch-receiver, and attaching said hitch-receiver to a vehicle. Said fogging system is capable of spraying a mixture of a chemical and a compressed air.

### BACKGROUND

This disclosure relates generally to a system and method for attaching a mobile fogger to a vehicle. Said fogger can be used for spraying and application of liquids and/or liquid-gas mixtures for a number of purposes such as: insect control/eradication, pesticide applications, medicinal or medical product spraying applications, including spraying antibiotics among livestock, chickens, pigs, etc. and antidotes for potential terrorist activities, herbicide applications, insecticide applications, paint applications, misting applications, cooling applications, water applications, fertilizer applications, horticultural applications, solid-stream applications, and application of cleaning/stripping/degreasing solutions for household and industrial uses. More particularly, the present disclosure relates to a cost effective, low-maintenance, and transportable liquid spraying system for the efficient application of liquid materials used to control insect populations, such as mosquito control products. For purposes of this disclosure, pesticides are discussed, and are an example of a fogging application. However, such discussion of pesticides is solely exemplary, and not limiting.

Systems and method for attaching a mobile fogger to a vehicle have evolved over the years. In one embodiment, mobile foggers are bolted or welded to a trailer and the trailer is thereafter attached to a vehicle for easy transportation. However, the utility of said embodiment is limited. For example, said embodiment requires a trailer which requires storage and will likely be substantially the size of a small car and will therefore require an entire parking space to be stored. Further, since said mobile fogger is attached to a trailer, it will be limited to the terrain the trailer, in-tow, can traverse. Still further, said embodiment may be complicated in attaching and detaching from a vehicle.

In another embodiment, a mobile fogger can be set into and secured to a bed of a truck. This embodiment fails in multiple variations. For example, in one embodiment, said mobile fogger may require a dedicated vehicle to its use and therefore eliminate the use of the vehicle for other uses. In another embodiment, said mobile fogger may be secured to the bed of the truck, but also include an apparatus for detaching said mobile fogger. This embodiment is inconvenient and will likely require multiple people to detach and reattach said mobile fogger from said vehicle. Further, it occupies the storage space, the bed, of the truck and therefore limits the utility of the vehicle.

As such it would be useful to have an improved mobile fogging system and method.

### SUMMARY

A mobile fogging system is disclosed. Specifically, said mobile fogging system comprising a base, a fogging system, and a hitch-receiver. Wherein, said fogging system is capable of spraying a mixture of a chemical and pressurizes air. Said fogging system is attached to said base. Further, said base is attached to a first end of said hitch-receiver, and a second end of said hitch-receiver is attached to a vehicle.

### BRIEF DESCRIPTION OF THE DRAWINGS

FIG. 1A illustrates a first end view of a mobile fogging system.

FIG. 1B illustrates a second end view of mobile fogging system.

FIG. 1C illustrates a detailed view of a first boom and a first assembly.

FIG. 2A illustrates an isolated view of one or more legs.

FIGS. 2B and 2C illustrate mobile fogging system with legs in a plurality of positions.

FIG. 3A and FIG. 3B illustrate two views of a hitch-connector aligned to a standard receiver hitch.

FIGS. 4A and 4B illustrates a standard adapter connecting hitch-receiver with standard receiver hitch.

FIG. 5A illustrates mobile fogging system attached to a truck and in a first legs position.

FIG. 5B illustrates mobile fogging system attached to truck and in a second legs position.

FIG. 5C illustrates an overview of mobile fogging system in second legs position and attached to truck.

FIG. 6A illustrates a mobile fogging system aligned with a tractor having a three-point hitch.

FIG. 6B illustrates a detailed view of three-point hitch.

FIGS. 7A and 7B illustrate two views of a three-point adapter.

FIG. 7C illustrates mobile fogging system attached to three-point hitch with three-point adapter.

FIG. 8A illustrates mobile fogging system attached to tractor with legs in first legs position.

FIG. 8B illustrates mobile fogging system attached to tractor with legs in second legs position.

FIGS. 9A and 9B illustrate mobile fogging system with a base wheel assembly, attached to tractor.

### DETAILED DESCRIPTION

Described herein is a system and method for attaching a mobile fogger to a vehicle. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

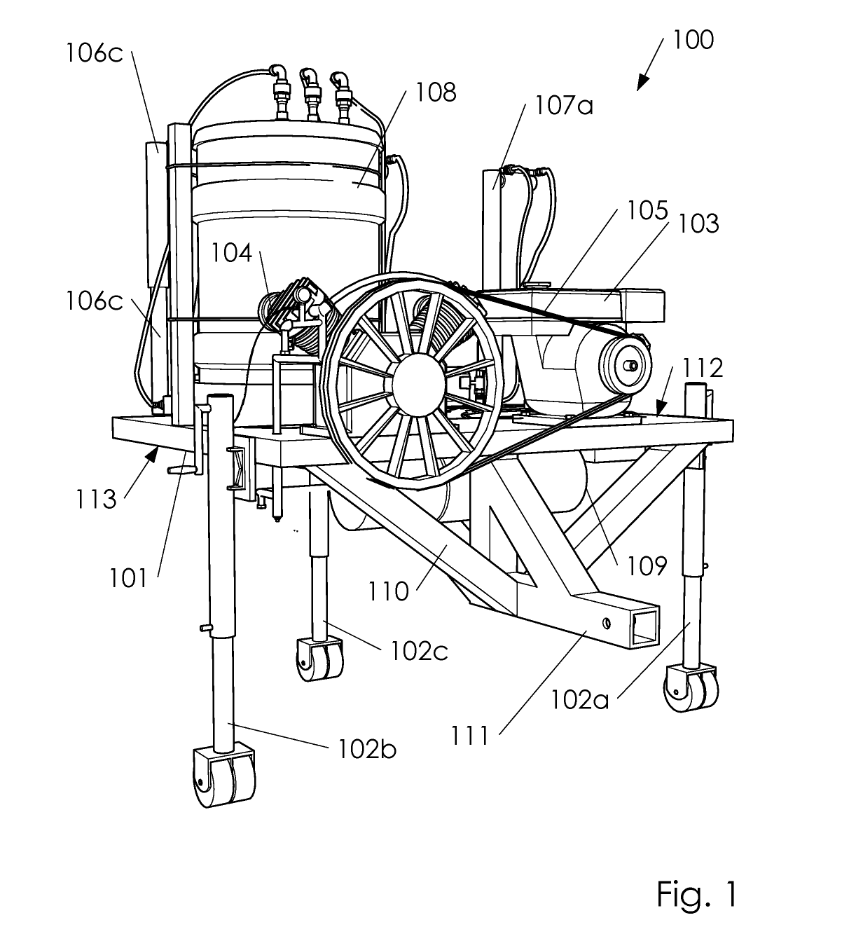

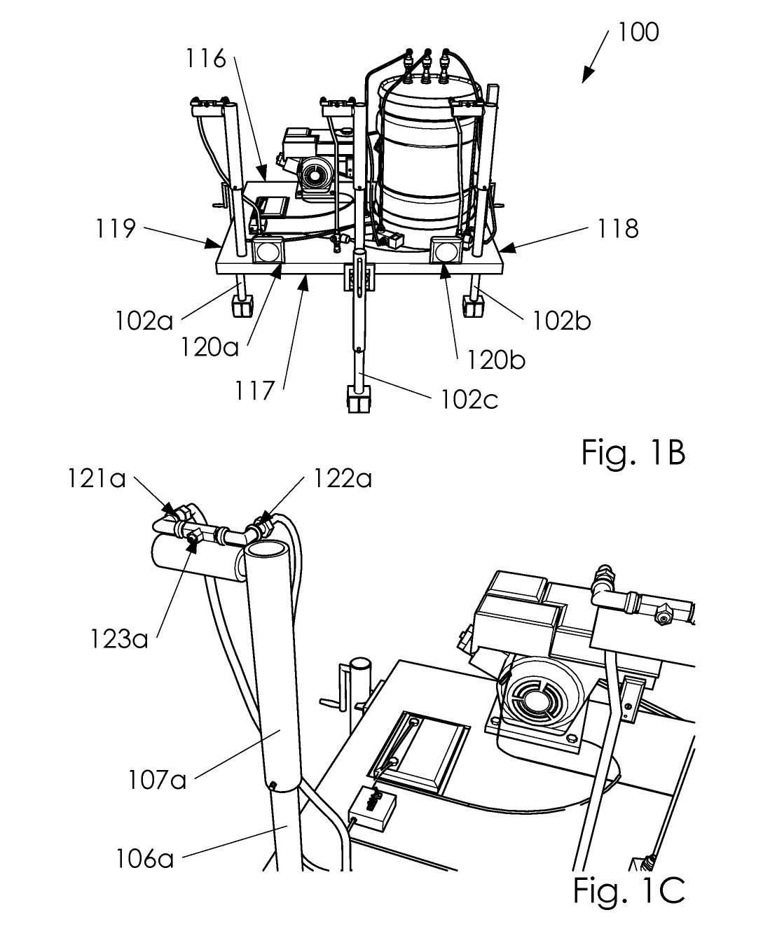

FIG. 1A illustrates a first end view of a mobile fogging system 100. Mobile fogging system 100 can comprise a base 101, one or more legs 102, an engine 103, an air compressor 104, a belt 105, one or more booms 106, one or more nozzle assemblies 107, a container 108, an air tank 109, one or more supports 110, and a hitch-receiver 111. Base 101 can comprise a base top 112 and a base bottom 113. Booms 106 can comprise a first boom 106a, a second boom 106b, and a third boom 106c. Nozzle assemblies 107 can comprise a first assembly 107a, a second assembly 107b, and a third assembly 107c. In one embodiment, engine 103, air compressor 104, booms 106, and container 108 can be attached to base top 112. In one embodiment, air tank 109 and supports 110 can be attached to base bottom 113. In one embodiment, hitch-receiver 111 can attach to supports 110. In one embodiment, hitch-receiver 111 can connect directly to base 101, bypassing supports 110. In one embodiment, air tank 109 can be attached to base bottom 113 above and protected by supports 110.

In one embodiment, the combination of engine 103, air compressor 104, and belt 105 can comprise an air source for mobile fogging system 100. In one embodiment, an air source supplies a compressed air 114 to nozzle assemblies 107. In one embodiment, compressed air 114 is first stored in air tank 109 prior to deliver to nozzle assemblies 107.

In one embodiment, container 108 contains a chemical 115 for delivery by mobile fogging system 100. In one embodiment, chemical 115 can comprise an oil- or water-based chemical, such as pesticides, fertilizer, or defoliant. In another embodiment, chemical 115 can comprise any chemical that needs to be distributed by mobile fogging system 100.

In another embodiment, air tank 109 can be capable of replacing base 101. For example, in one embodiment, air tank 109 can be substantially in the form of a rectangular platform, capable of supporting the components of mobile fogging system 100.

In one embodiment, air compressor 104 can provide compressed air for tasks not strictly related to the core uses of mobile fogging system 100. For example, in one embodiment, pneumatic tools can acquire a compressed air source from air compressor 104 or air tank 109. In one embodiment, pneumatic tools can comprise an air impact wrench, an airbrush, a jackhammer, a pneumatic grinder, a pneumatic sander, a pneumatic drill, a pneumatic screwdriver, a pneumatic paint gun, a pneumatic nail gun, or the like.

FIG. 1B illustrates a second end view of mobile fogging system 100. Base 101 can further comprise a first end 116, a second end 117, a first side 118, and a second side 119.

Mobile fogging system 100 can further comprise one or more taillights 120. Taillights 120 can comprise a first taillight and a second taillight. In one embodiment, first taillight 120a and second taillight 120b can be incorporated into a breaking and signaling system of a vehicle which is attached to mobile fogging system 100.

Legs 102 can comprise a first leg 102a, a second leg 102b, and a third leg 102c. In one embodiment, first leg 102a can attach to second side 119, second leg 102b can attach to first side 118, and third leg 102c can attach to second end 117.

FIG. 1C illustrates a detailed view of first boom 106a and first assembly 107a. Nozzle assemblies 107 can comprise a first input 121, a second input 122, and a nozzle output 123. In one embodiment, chemical 115 and compressed air 114 are mixed in and ejected from nozzle assemblies 107. For example, in one embodiment, compressed air 114 can be fed into a first input 121a, chemical 115 can be fed into a second input 122a, compressed air 114 and chemical 115 can be mixed in nozzle assembly 107a, and ejected from nozzle output 123. In one embodiment, chemical 115 can be pulled into nozzle assembly 107 by suction created in nozzle assembly 107. In another embodiment, chemical 115 can be pushed into nozzle assembly 107 by a fluid pump or other pushing means fluidly between container 108 and nozzle assemblies 107.

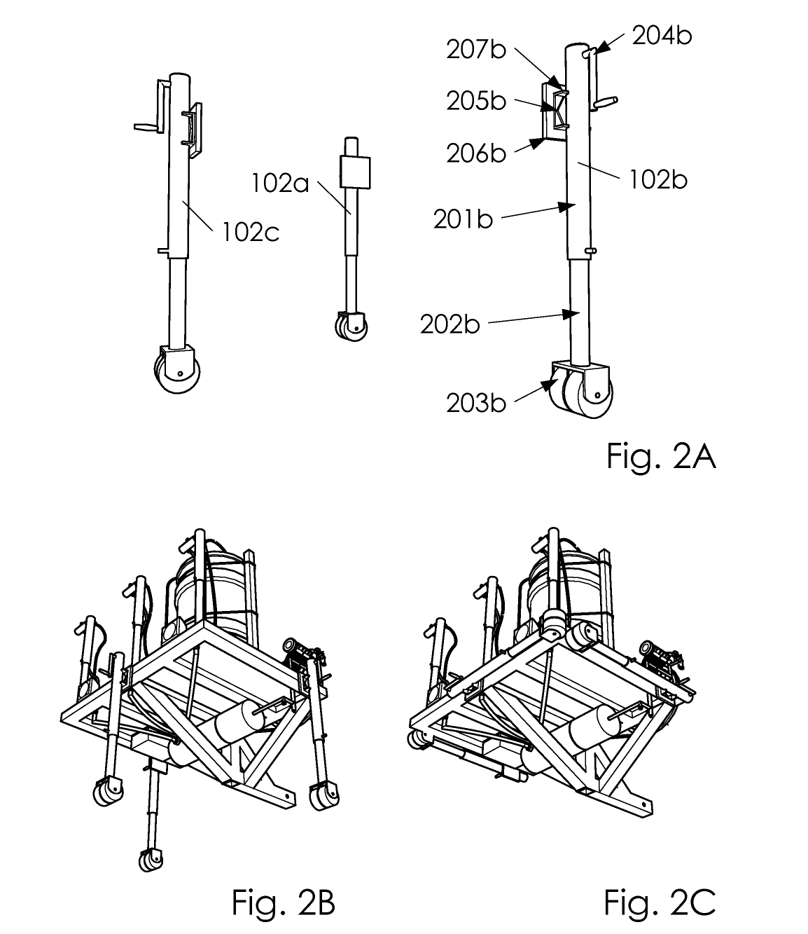

FIG. 2A illustrates an isolated view of one or more legs 102. Each of legs 102 can comprise a first segment 201, a second segment 202, a leg wheel assembly 203, a crank 204, a rotating bracket 205, a leg mount 206, and a pin 207. In one embodiment, second segment 202 can telescope from within first segment 201 as crank 204 is turned. In one embodiment, each of legs 102 can be removed from mobile fogging system 100 by pulling pin 207 and lifting legs 102 out and away from mobile fogging system 100.

In one embodiment, leg mount 206b can attach first side 118 to rotating bracket 205b, and rotating bracket 205b can attach first portion 201b to leg mount 206b. In one embodiment, first portion 201b and leg wheel assembly 203b are attached at opposite ends of second portion 202b. In one embodiment, leg wheel assembly 203b can pivot freely about the base of second portion 202b to allow second leg 102b to change direction easily.

FIGS. 2B and 2C illustrate mobile fogging system 100 with legs 102 in a plurality of positions. In one embodiment, rotating bracket 205b can allow legs 102 to rotate and lock into at a plurality of positions. For example, in one embodiment, second leg 102b can have a first legs position substantially perpendicular to base bottom 110 (as in FIG. 2B) and a second legs position substantially parallel with base bottom 110 (as in FIG. 2C). While in first legs position, mobile fogging system 100 can be easily rolled around on leg wheel assemblies 203. Further, while in first legs position, the height of mobile fogging system 100 can be adjusted by turning cranks 204 which can be internally attached to a screw thread to apply a high linear force. For example, in one embodiment, a user of mobile fogging system 100 in first legs position can roll hitch-connector 111 near to a vehicle's receiver-type trailer hitch, readjust the height of legs 102 with cranks 204, attach mobile fogging system 100 to a vehicle, and rotate legs 102 up into second legs position. Accordingly, mobile fogging system 100 is capable of simplifying common configuration tasks. Likewise, while in second legs position, mobile fogging system 100 can be strapped down onto a flat surface, such as a bed of a pickup truck.

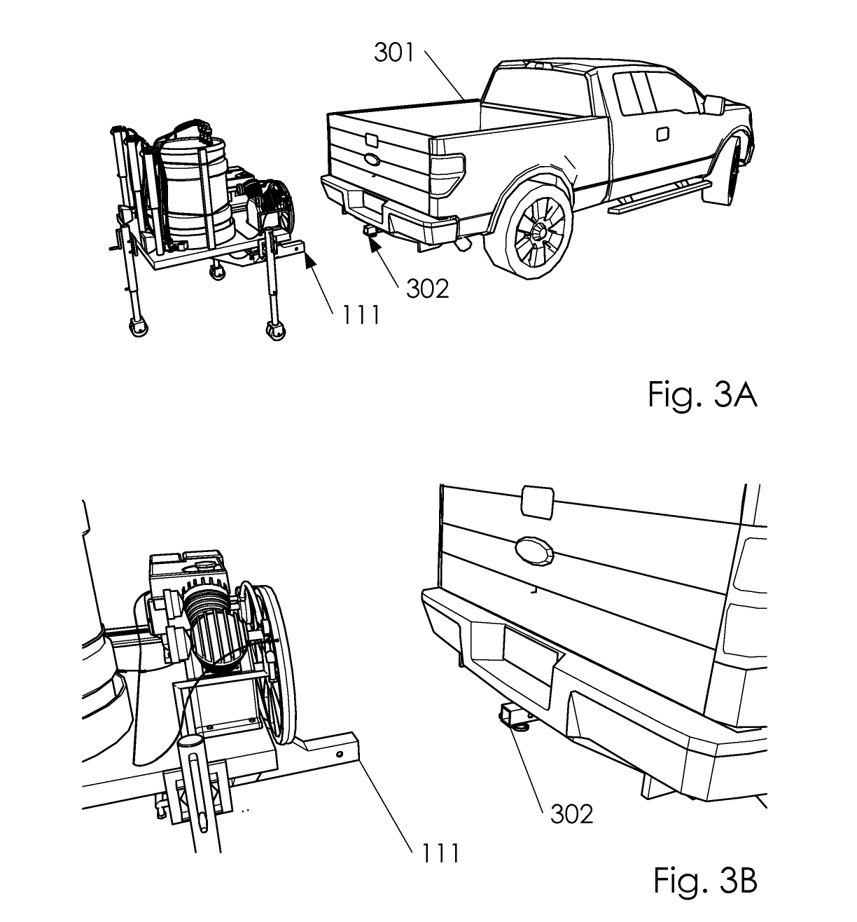

FIG. 3A and FIG. 3B illustrate two views of hitch-connector 111 aligned to a standard receiver hitch 302. In one embodiment, mobile fogging system 100 can attach to a vehicle with standard receiver hitch 302. In one embodiment, standard receiver hitch 302 can comprise a portion that can mount to the frame of the vehicle that has a rearward facing opening that accepts ball mounts, cargo carriers, or other hitch mounted accessories. For example, in one embodiment, said vehicle can be a truck 301 with standard receiver hitch 302. In one embodiment, truck 301 can comprise a tow-ball, rather than a standard receiver hitch 302, capable of allowing swiveling and articulation of a trailer, or a tow pin and jaw with a trailer loop.

In another embodiment, mobile fogging system 100 can be carried in a bed of truck 301, bypassing the need for hitch-connector 111.

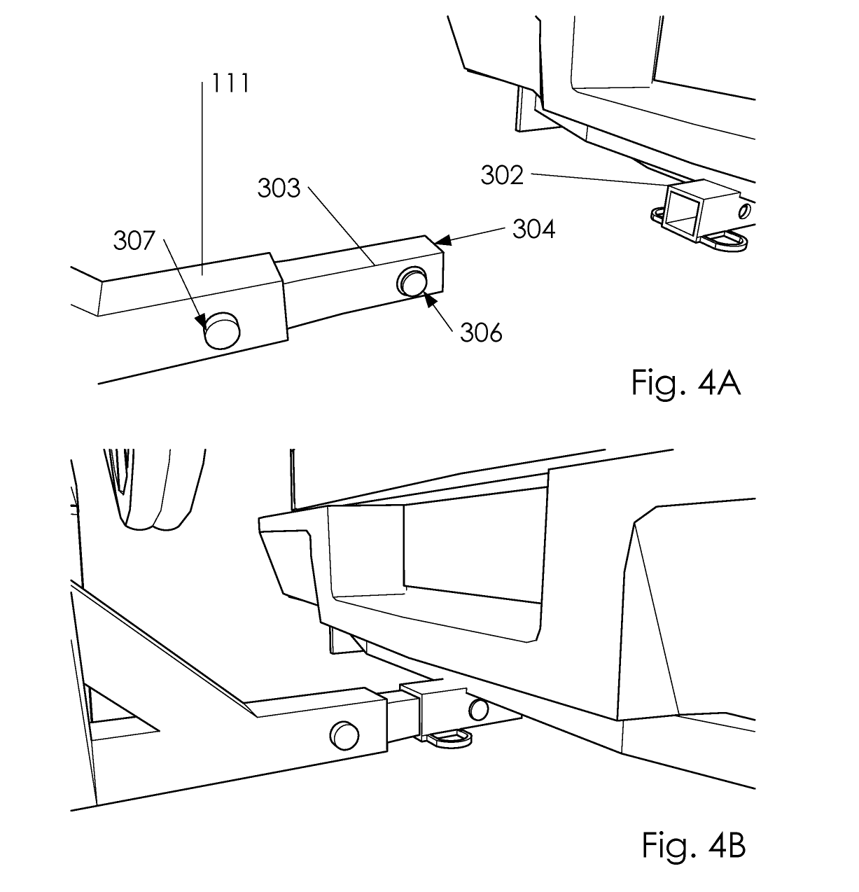

FIGS. 4A and 4B illustrates a standard adapter 303 connecting hitch-receiver 111 with standard receiver hitch 302. Mobile fogging system 100 can comprise standard adapter 303 capable of attaching hitch-receiver 111 to standard receiver hitch 302. Standard adapter 303 can comprise a first end 304, a second end 305, a first pin 306, and a second pin 307. In one embodiment, first pin 306 can be inserted through first end 304 and second pin 307 can be inserted through second end 305. In one embodiment, first pin 306 and second pin 307 can be removed from and reinserted into standard adapter 303. In one embodiment, mobile fogging system 100 can be attached to truck 301 by removing first pin 306 and second pin 307 from standard adapter 303, inserting first end 304 into standard receiver hitch 302, inserting second end 305 into hitch-receiver 111, inserting first pin 306 through standard receiver hitch 302 and first end 304, and inserting second pin 307 through second end 305 and hitch-receiver 111.

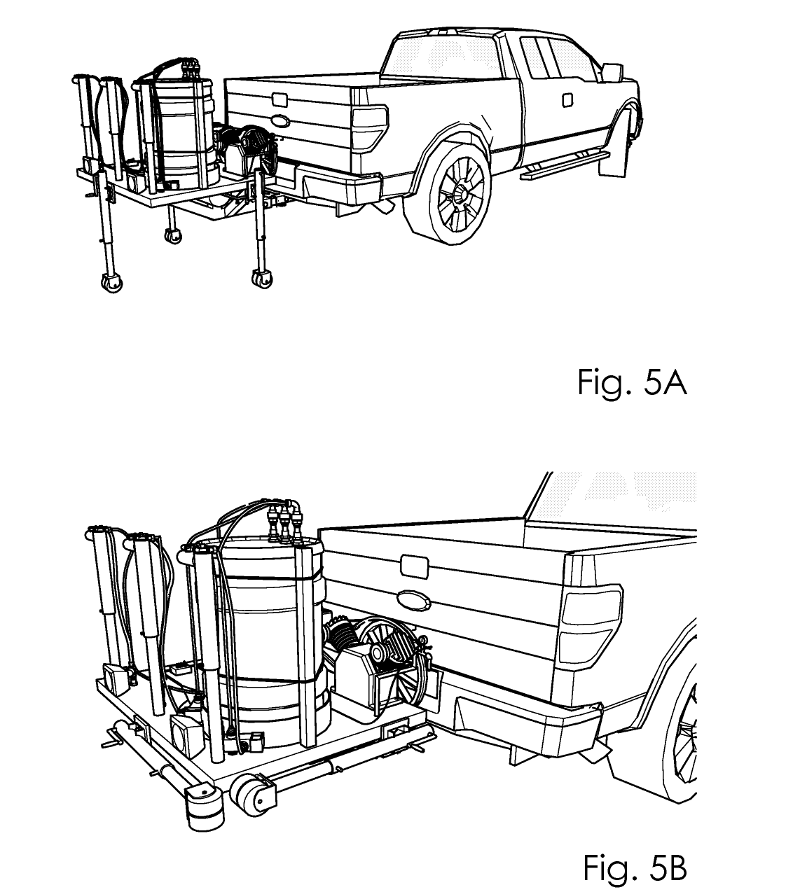

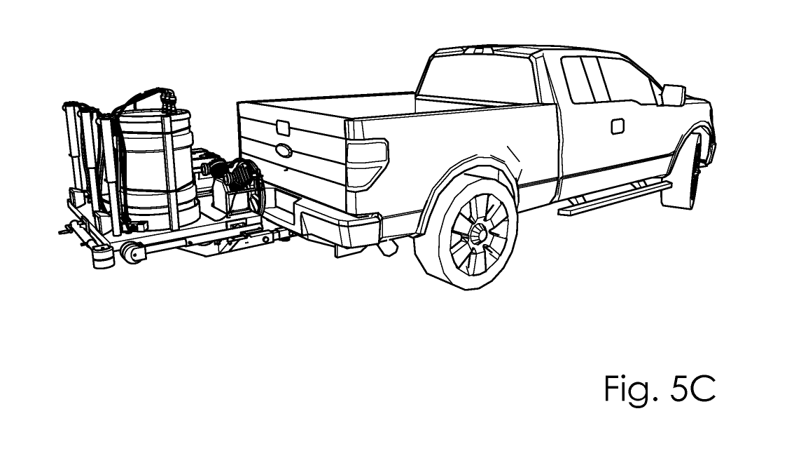

FIG. 5A illustrates mobile fogging system 100 attached to truck 301 and in first legs position.

FIG. 5B illustrates mobile fogging system 100 attached to truck 301 and in second legs position. Once mobile fogging system 100 is attached to a vehicle (such as truck 301) with standard receiver hitch 302, legs 102 can be reconfigured so as to not interfere with the movement of truck 301. For example, in one embodiment, legs 102 can be rotated and locked into second legs position. In another embodiment, legs 102 can be removed from mobile fogging system 100 to eliminate interference with the movement of truck 301.

FIG. 5C illustrates an overview of mobile fogging system 100 in second legs position and attached to truck 301.

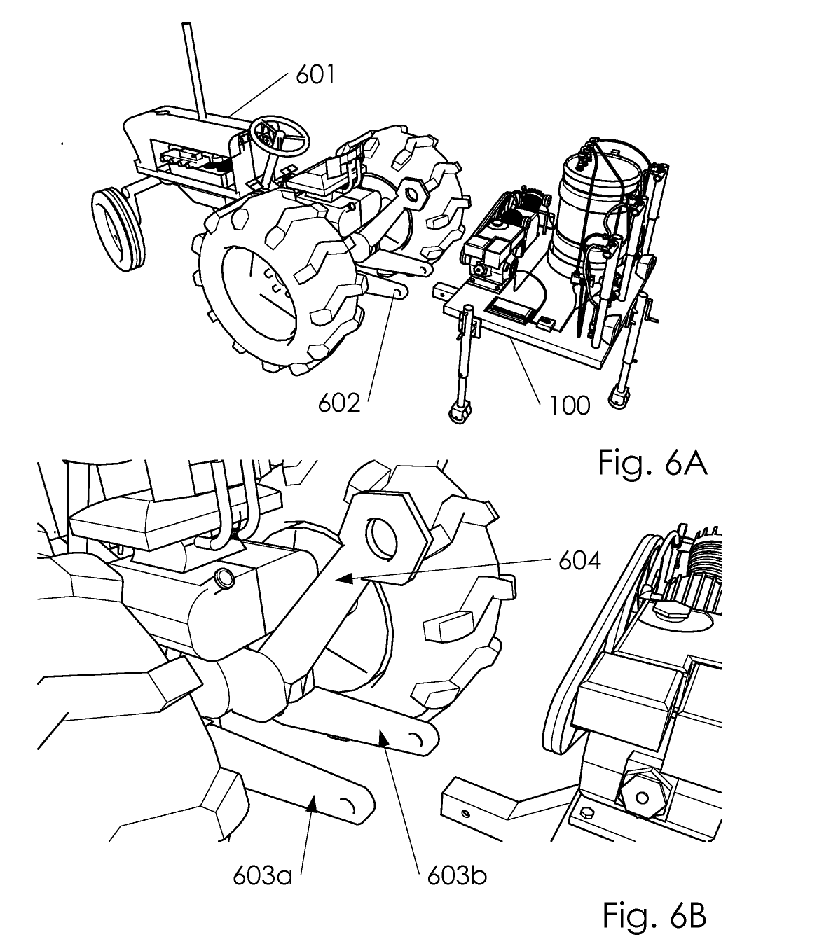

FIG. 6A illustrates a mobile fogging system 100 aligned with a tractor 601 having a three-point hitch 602. In one embodiment, mobile fogging system 100 may be attached to and operate behind tractor 601. Tractor 601 can comprise three-point hitch 602, as is common in the art. In one embodiment, tractor 601 can comprise a standard receiver hitch 302. Accordingly, mobile fogging system 100 can connect to tractor 601 in a similar manner to how it does with truck 301. However, where three-point hitch 602 is in use, an adapter must be used to attach mobile fogging system 100 to tractor 601.

FIG. 6B illustrates a detailed view of three-point hitch 602. Three-point hitch 602 can comprise one or more side arms 603 and an articulating arm 604.

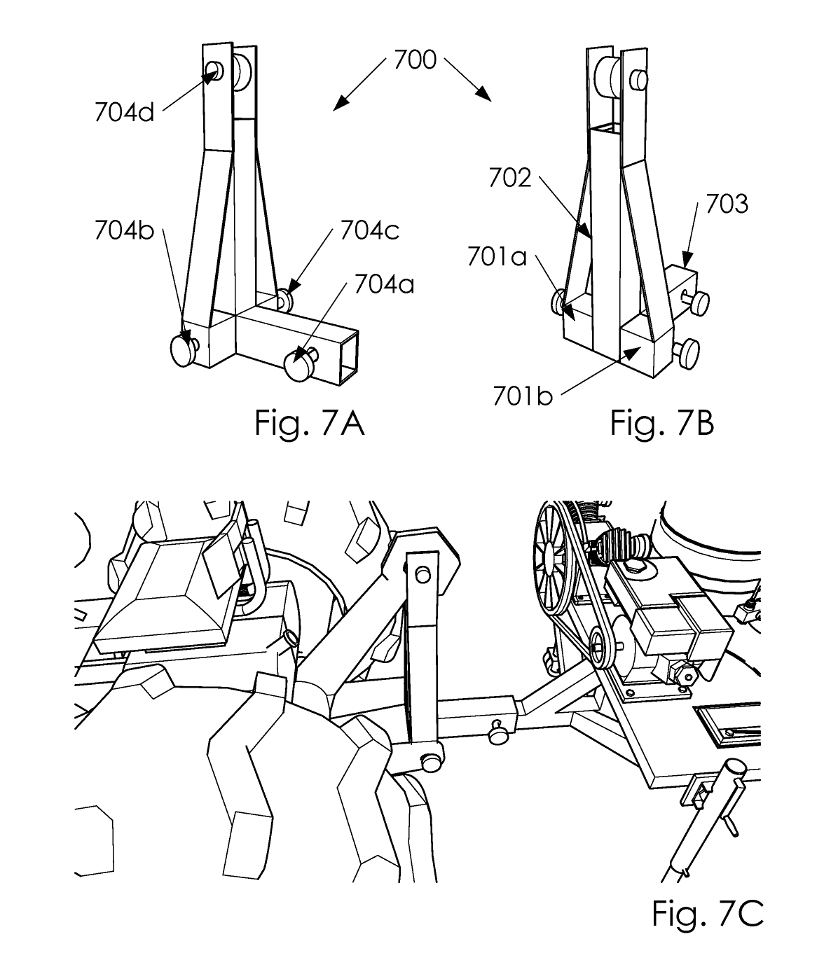

FIGS. 7A and 7B illustrate two views of a three-point adapter 700. Three-point adapter 700 can comprise one or more sidebars 701, a top bar 702, an adapter bar 703, and one or more pins 704. In one embodiment, top bar 702, adapter bar 703, and a midpoint of sidebars 701 can attach to one another at a middle junction; further, the opposite ends of sidebars 701, top bar 702, and adapter bar 703 can each have on of pins 704 attached to one or more exterior ends, as show in FIGS. 7A and 7B.

FIG. 7C illustrates mobile fogging system 100 attached to three-point hitch 602 with three-point adapter 700. In one embodiment, mobile fogging system 100 can attach to tractor 601 with three-point adapter 700 by attaching top bar 702 to articulating arm 604, attaching sidebars 701 to side arms 603, and attaching adapter bar 703 to hitch-receiver 111. Further, in one embodiment, each component can attach by inserting one of pins 704 into said component and said portion of three-point adapter 700.

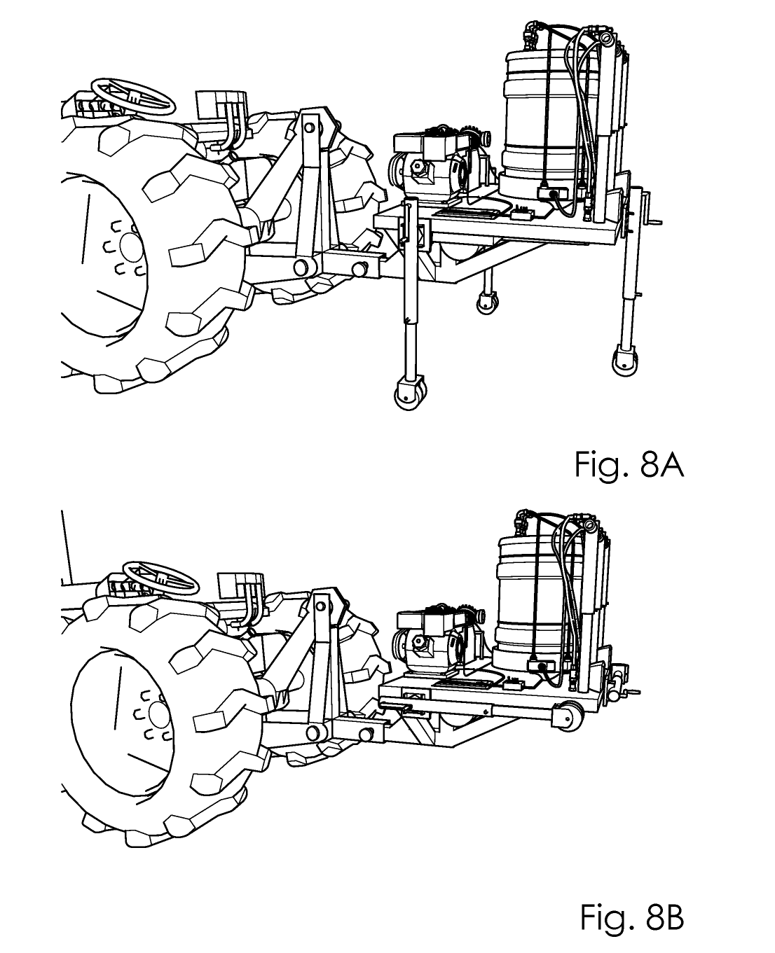

FIG. 8A illustrates mobile fogging system 100 attached to tractor 601 with legs 102 in first legs position.

FIG. 8B illustrates mobile fogging system 100 attached to tractor 601 with legs 102 in second legs position.

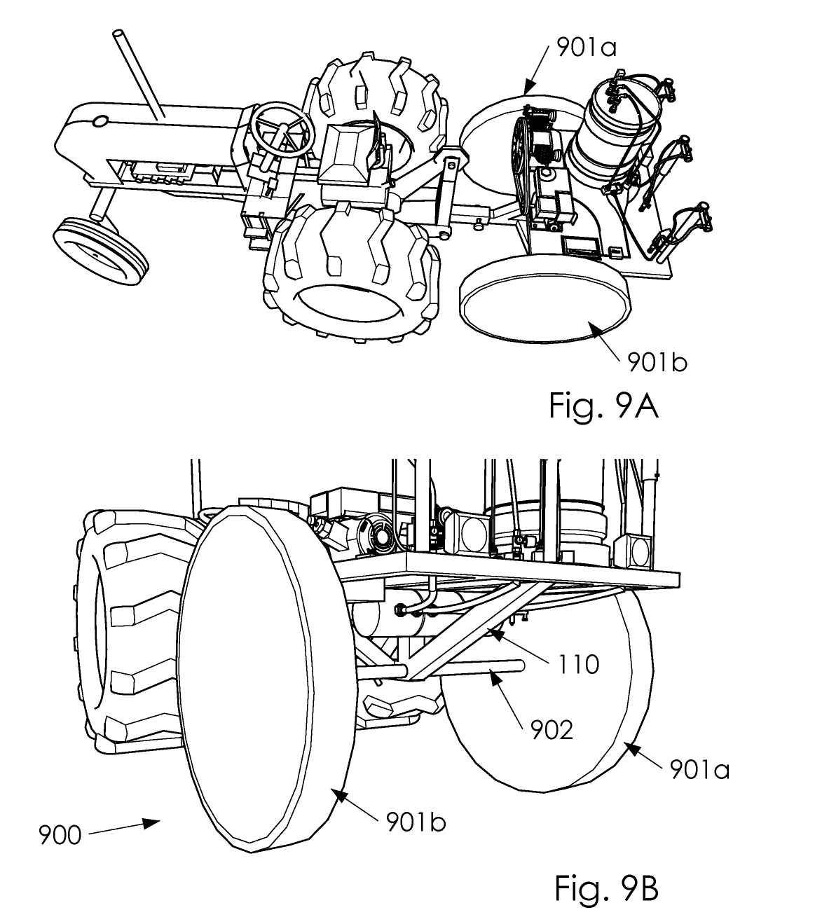

FIGS. 9A and 9B illustrate mobile fogging system 100 with a base wheel assembly 900, attached to tractor 601. Mobile fogging system 100 can comprise base wheel assembly 900. In one embodiment, base wheel assembly 900 can comprise two wheels 901 and an axel 902. In one embodiment, mobile fogging system 100 can be attached and dragged behind a vehicle, such as a car, truck, tractor, all-terrain vehicle, or the like.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive, For example, the above-described embodiments may be used in combination with each other, Many other embodiments will be apparent to those of skill in the art upon reviewing the above description, The scope of the invention should, therefore, be determined with reference to the appended claims, along with the full scope of equivalents to which such claims are entitled, In the appended claims, the terms “including” and “in which” are used as the plain-English equivalents of the respective terms “comprising” and “wherein.”

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A mobile fogging system comprising:
a base having a top and a bottom;
a fogging system, capable of spraying a mixture of a chemical and pressurizes air, attached to said base; and
a hitch-receiver having a first end and a second end; wherein
said first end is connected to said base and said
second end is capable of attaching to a vehicle.

2. The mobile fogging system of claim 1 further comprising an adapter wherein said second end of said hitch-receiver attaches to said adapter and said adapter attaches to said vehicle.

3. The mobile fogging system of claim 2 wherein said adapter comprises a standard adapter, wherein
said hitch-receiver attaches to a first end of said standard adapter,
a standard receiver hitch attaches to a second end of said standard adapter, and
said standard receiver hitch attaches to said vehicle.

4. The mobile fogging system of claim 2 wherein
said adapter comprises a three-point adapter, and
said vehicle comprises a three-point hitch; further wherein
said three-point adapter attaches to said three-point hitch.

5. The mobile fogging system of claim 1 further comprising a base wheel assembly, having an axel and two wheels; wherein,
said fogging system is attached to said vehicle,
said base wheel assembly is attached to said fogging system, and
said mobile fogging system is dragged on said base wheel assembly.

6. The mobile fogging system of claim 1 further comprising one or more legs each having a first end and a second end, wherein said first end of said legs are attached to said base.

7. The mobile fogging system of claim 6 wherein said legs each further comprise a leg wheel assembly attached to said second end of said legs.

8. The mobile fogging system of claim 6 wherein:
said legs further comprise a first segment, a second segment, and a crank;
said crank is attached to a screw thread jack inside of said legs; and
said crank rotates in two rotary directions capable of adjusting a relative height of said base, wherein
rotating said crank in a first rotary direction extends said second segment of said legs from within said first segment of said legs, and
rotating said crank in a second rotary direction detracts said second segment of said legs back into said first segment of said legs.

9. The mobile fogging system of claim 6 wherein said legs each further comprise a rotating bracket; wherein
said rotating brackets attach said legs to said base, and
said rotating brackets rotate and lock into a plurality of positions.

10. The mobile fogging system of claim 9 wherein
said plurality of positions comprise a first legs position and a second legs position;
further wherein
said first legs position comprises said legs substantially perpendicular to said base, and
said second legs position comprises said legs substantially parallel to said base.

11. The mobile fogging system of claim 6 wherein said legs comprise as a release capable of releasing and reattaching said legs from said base.

12. The mobile fogging system of claim 1 wherein
said mobile fogging system is capable attaching to said vehicle and being used while said vehicle is in motion without a trailer by
attaching said base to said vehicle with said hitch-receiver,
supporting said mobile fogging system on said hitch-receiver, and
holding said mobile fogging system off the ground.

13. A mobile fogging method comprising:
attaching a fogging system, capable of spraying a mixture of a chemical and a compressed air, to a base;
attaching said base to a hitch-receiver; and
attaching said hitch-receiver to a vehicle.

14. The mobile fogging method of claim 13 wherein attaching said hitch-receiver to said vehicle comprises
attaching said hitch-receiver to an adapter, and
attaching said adapter to said vehicle.

15. The mobile fogging method of claim 13 further comprising:
attaching one or more legs to said base, and
supporting said fogging system with said legs.

16. The mobile fogging method of claim 15 further comprising:
attaching one or more leg wheel assemblies to each of said legs;
positioning said hitch-receiver in alignment with said vehicle by rolling said fogging system and said base on said wheel asemblies;
adjusting a height of each of said legs; and
attaching said hitch-receiver to said vehicle.

17. The mobile fogging method of claim 16 wherein adjusting said height of said legs comprises:
rotating a crank, attached to a screw thread jack inside of said legs, in one of two rotary directions; wherein
rotating said crank in a first rotary direction extends a second segment of said legs from within a first segment of said legs, and
rotating said crank in a second rotary direction detracts said second segment of said legs back into said first segment of said legs.

18. The mobile fogging method of claim 15 further comprising:
rotating said legs into a first legs position and a second legs position; and
locking said legs into said first legs position and said second legs position once said legs have reached said positions; wherein
said first legs position comprises said legs substantially perpendicular to said base, and
said second legs position comprises said legs substantially parallel to said base.

19. The mobile fogging method of claim 18 further comprising:
aligning said hitch-receiver with said vehicle with legs in said first legs position;
attaching said hitch-receiver to said vehicle;
rotating said legs into said second legs position;
locking said legs into said second legs position so as to minimize interference with the movement of said vehicle;
spraying said fogging system; and
driving said vehicle along a treatment path.

20. The mobile fogging method of claim 15 further comprising removing said legs prior to driving said vehicle so as to minimize interference with the movement of said vehicle.

21. The mobile fogging method of claim 18 further comprising:
aligning said hitch-receiver with said vehicle with legs in said first legs position;
attaching said hitch-receiver to said vehicle;
attaching a base wheels assembly, having an axel and two wheels, to said base;
rotating said legs into said second legs position;
locking said legs into said second legs position so as to minimize interference with the movement of said vehicle;
spraying said fogging system; and
driving said vehicle along a treatment path while dragging said fogging system and said base on said base wheel assembly.
